(19) United States
(12) Patent Application Publication
(10) Pub. No.: US 2026/0042102 A1
(43) Pub. Date: Feb. 12, 2026

(54) METHODS AND COMPOSITIONS FOR TREATING PARTITIONED FLOWS

(71) Applicant: Eoolab USA Inc., St. Paul, MN (US)

(72) Inventors: Christopher Ryan Greulich, Elburn, IL (US); Michael Ignazio LaRosa, Tucson, AZ (US)

(21) Appl. No.: 19/296,140

(22) Filed: Aug. 11, 2025

Related U.S. Application Data
(60) Provisional application No. 63/681,919, filed on Aug. 12, 2024.

(51) Int. Cl. B03D 1/08

(52) U.S. Cl. CPC B03D 1/082; B03D 2203/02

(57) ABSTRACT

Methods of improving the stability of froth flotation overflows and underflows include adding 1 ppm to 1000 ppm by weight of a cationic polymer to an overflow or an underflow including 1 wt % to 20 wt % of a particulate product in a medium, wherein the particulate product is a valuable mineral product or a gangue. In particular, the addition of cationic polymer to a tailings flow—that is, a gangue in a fluid medium-reduces or eliminates “sanding”, a term of art used to describe the technical problem of deposition of gangue solids from tailings flows transported through pipes, tubes, and runways during transportation thereof e.g. to a thickener bed.

### BACKGROUND

Froth flotation is a method widely used in the mining industry to partition liberated mineral products from the rock matrix materials, or “gangue”, present in a comminuted mineral ore. In conventional froth flotation, water along with one or more chemicals are added to a comminuted mineral ore having a particle size of less than 500 μm, often less than 250 μm or even 100 μm or less, to form an ore slurry; and the ore slurry is aerated, for example by sparging, to form a plethora of bubbles therein that move toward the surface of the ore slurry to form a froth thereon. The chemicals in the ore slurry are selected by the operator to promote association of valuable mineral-bearing particles—that is, the mineral product—with the bubbles, support the mineral product within the froth, and withstand the physical manipulation of collecting the froth, thereby enabling the partitioning and separation of the mineral product from the ore slurry by collecting the froth from the surface of the ore slurry. The gangue particles tend to remain in the slurry due to the selectivity of the froth, further as promoted by the chemicals added to the ore slurry.

Reverse froth flotation works in accordance with the same principles and methodology as conventional froth flotation, except that the operator adds chemicals to the mineral ore slurry to promote adhesion of the gangue particles to the froth. Accordingly, in reverse froth flotation, the gangue particles are collected with the froth; and the mineral product remains in the slurry and is collected therefrom.

On an industrial scale, both conventional and reverse froth flotation are achieved in multiple steps by subjecting a stream of a mineral ore slurry to a continuous series, or a circuit, of flotation cells. The mineral product is partitioned from the gangue, and the partitioned streams are collected from the flotation circuit and passed on to a subsequent step in the selected mineral process. Industrially, a froth collected from the surface of an aerated mineral ore slurry is referred to as an “overflow” while the slurry remaining after collecting the froth therefrom is referred to as the “underflow”. An overflow or an underflow including a gangue is referred to industrially as “tailings” or “tailings flow”. An overflow or underflow including a mineral product is referred to herein as a “mineral product flow”.

Overflows and underflows collected from froth flotation containments, that is, froth flotation cells or circuits, including combined overflows and underflows obtained from a plurality of froth flotation cells, are slurries including relatively low concentrations of a particulate product that is either a mineral product or gangue dispersed herein, often about 20 wt % or less of the particulate product dispersed therein. Accordingly, a subsequent step to concentrate an overflow or an underflow by removing a portion of the water therefrom is often carried out by an operator. During concentration of an overflow or underflow, least about 10 wt %, often 20% or more of the medium by volume or by weight is removed from the partitioned flow to form a concentrated flow therefrom. Industrially, the process of forming a concentrated flow from a partitioned flow is referred to as “thickening”. A concentrated overflow or underflow includes at least 30 wt % solids. Often, a concentrated overflow or underflow includes 40 wt % solids or more.

For example, tailings are often thickened by sedimentation or filtration or a combination thereof to recover water for re-use within the mineral processing circuitry (including but not limited to the froth flotation circuit) at one or more locations, prior to further treating or disposing of the tailings solids. In some cases a tailings flow is further dewatered by a final filtration to form a tailings concentrate; in other cases, the partly-dewatered tailings are stored in a tailings pond. Accordingly, a tailings concentrate or a partly-dewatered tailings concentrate includes at least 30 wt % solids. Often, a tailings concentrate includes 40 wt % solids or more.

In order to thicken, or concentrate, an overflow or an underflow, it must be transported from a froth flotation containment or cell, to a containment adapted and designed to concentrate a slurry of particles within a liquid medium: that is, a containment for carrying out one or more sedimentation, evaporation, filtration, or other processes for removing water from an overflow or underflow. Industrially, such concentration containments are referred to as “thickener beds”. In many mineral ore processing plants, after partitioning an overflow from an underflow in a froth flotation cell or circuit, the overflow having 20 wt % solids or less is applied to a first conduit in fluid connection with a first thickener bed, and transported through the first conduit and into a first thickener bed, and concentrated in the first thickener bed to form a first concentrate having 30 wt % solids or more; and the underflow having 20 wt % solids or less is applied to a second conduit in fluid connection with a second thickener bed, and transported through the second conduit and into the second thickener bed, and concentrated in the second thickener bed to form a second concentrate having 30 wt % solids or more.

During the transportation of an underflow or overflow from a flotation containment or flotation circuit through a conduit and toward and even into a thickener bed, some of the solids present in the underflow or overflow can become deposited at a slurry-conduit interface: that is, solids are deposited onto the interior surface of a conduit contacted by the overflow or underflow during transit thereof between a froth flotation cell and a thickener bed. In particular, agglomerated particulate solids that are not stably dispersed in an overflow or an underflow may “fall out” of the overflow or underflow and become deposited on the interior surface of a conduit during transportation thereof through the conduit, that is, before reaching the thickener bed. Such deposited solids can remain associated with the conduit interior surface, building up over time and leading to severe problems for operators in maintaining reasonable rates of overflow and/or underflow transport. Eventually, the deposited solids can block or substantially block the conduit, and the entire processing system must be shut down to clear the blockage. Further, additional deposition can occur in the area of the thickener bed proximal to the inlet that receives the overflow or underflow from the conduit, causing further problems with operation of the equipment within thickener bed, such as over-torquing of rakes used to agitate the contents and direct slurry flow therein.

It is believed that use of larger particle sizes of a comminuted ore, high density and/or variable density of particles within an underflow or an overflow, and increased throughput, or rate of flow, of an underflow or overflow through a conduit may all be contributing factors in deposition of solids from partitioned underflows and overflows. Regarding large particle size, some particles having one or more dimensions of e.g. 200 microns, or up to 250 microns, or even up to 300 microns, or larger can be found in particulates (that is, groups of particles) having much smaller average or median particle size; and these particles contribute to deposition during transportation through a conduit since they tend to drop out of the moving flow and remain within the conduit. Regarding high density ore particulates, ore particulates having overall specific gravity of more than about 4.0 g/cm³, such as 4.5 g/cm³ or more contribute to deposition during transportation through a conduit because since these particles cannot be supported by the moving flow of the lower-density water. Regarding low slurry density, an overflow or underflow having an overall specific gravity of less than 2 g/cm³, such as 1.8 g/cm³ or less, or even 1.5 g/cm³ or less, contribute to deposition during transportation through a conduit.

These problems are particularly severe in the case of tailings overflows and underflows (collectively, tailings or tailings flows), to the extent that the industry has assigned a special name to the problem: “sanding”. The recognized severity of sanding may relate to the chemical diversity of the tailings flows when compared to mineral product flows, which commonly target one chemical specie or a narrow range of similar chemical species. Chemical species present in one or more gangues related to one or more mineral ores include silica and a range of silicate minerals including aluminosilicates e.g. feldspar, clays, etc.; carbonates such as calcium carbonate, e.g. calcite; sulfides such as iron sulfide e.g. pyrite; oxides such as iron oxide; and others present in a variety of crystalline and non-crystalline forms. The variety of materials present in a tailings flow provides density differences between different particles, and more opportunities for destabilization through chemical associations and/or charge destabilization than does a mineral product flow.

The problem of buildup of deposited solids within the conduits used to transport froth flotation overflows and underflows from froth flotation cells into thickener beds, including the problem of sanding, remains largely unaddressed and therefore responsible for significantly reduced productivity in many mineral ore processing facilities.

Accordingly, there remains a need in the mineral ore processing industry to solve the problem of deposition of particulate products by froth flotation overflows and underflows prior to concentration thereof. In particular, there remains a need in the industry to reduce or eliminate deposition of particulate products (mineral product or gangue) onto conduit interior surfaces during transportation of partitioned flows therethrough. The need remains most acute in the case of sanding caused by tailings flows, in particular tailings flows obtained from froth flotation partitioning of copper/moly ores.

### SUMMARY OF THE INVENTION

Described herein are treated partitioned flows comprising, consisting essentially of, or consisting of a mixture of a cationic polymer with a partitioned flow, where the partitioned flow is an underflow or an overflow from a froth flotation of a mineral ore. Also described herein are methods of treating a partitioned flow from a froth flotation of a mineral ore, the methods comprising, consisting essentially of, or consisting of adding a cationic polymer to the partitioned flow to form a treated partitioned flow, where the partitioned flow is an underflow or an overflow collected from a froth flotation of a mineral ore. The settling rate of a particulate product present in a treated partitioned flow is reduced 10% to 100% compared to the rate of settling of the particulate product from the same partitioned flow in the absence of the cationic polymer.

In embodiments, the partitioned flow is an underflow or an overflow that is collected, that is, physically separated from a froth flotation of a mineral ore selected from a gold ore, a silver ore, an iron ore, an alumina ore (bauxite ore), a copper ore, a molybdenum ore, a sulfide ore, a lead ore, a zinc ore, or a copper/moly ore. In embodiments, the partitioned flow includes 20 wt % or less of a particulate product. In some embodiments, the particulate product comprises, consists essentially of, or consists of a mineral product; in other embodiments, the particulate product comprises, consists essentially of, or consists of a gangue.

In embodiments, the cationic polymer comprises, consists essentially of, or consists of a poly(diallyldimethylammonium halide). In embodiments, the cationic polymer is added to a partitioned flow in an amount of 1 ppm to 1000 ppm by weight, based on the weight of particulate product in the partitioned flow, to form the treated partitioned flow.

In embodiments, a treated partitioned flow is disposed within a containment or a conduit. In a preferred embodiment, the conduit is a raceway extending between, and in fluid communication with, a froth flotation cell and a thickener bed; and the treated partitioned flow disposed therein is transported within the raceway in a direction from the froth flotation cell toward the thickener bed. In embodiments, the transporting includes moving the treated partitioned flow through the conduit at a rate of 100 metric tons to 10,000 metric tons of the particulate product per hour. In embodiments, the transporting includes moving the treated partitioned flow through the conduit at a rate of about 10 cm/s to about 20 m/s.

Other objects and features will be in part apparent and in part pointed out hereinafter.

### DETAILED DESCRIPTION

Although the present disclosure provides references to preferred embodiments, persons skilled in the art will recognize that changes may be made in form and detail without departing from the spirit and scope of the invention. Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

### Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “optional” or “optionally” means that the subsequently described event or circumstance may but need not occur, and that the description includes instances where the event or circumstance occurs and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about”the claims appended hereto include equivalents to these quantities. Further, where “about” is employed to describe a range of values, for example “about 1 to 5” the recitation means “1 to 5” and “about 1 to about 5” and “1 to about 5” and “about 1 to 5” unless specifically limited by context.

As used herein, the term “substantially” means “consisting essentially of”, as that term is construed in U.S. patent law, and includes “consisting of” as that term is construed in U.S. patent law. For example, a solution that is “substantially free” of a specified compound or material may be free of that compound or material, or may have a minor amount of that compound or material present, such as through unintended contamination, side reactions, or incomplete purification. A “minor amount” may be a trace, an unmeasurable amount, an amount that does not interfere with a value or property, or some other amount as provided in context. A composition that has “substantially only” a provided list of components may consist of only those components, or have a trace amount of some other component present, or have one or more additional components that do not materially affect the properties of the composition. Additionally, “substantially” modifying, for example, the type or quantity of an ingredient in a composition, a property, a measurable quantity, a method, a value, or a range, employed in describing the embodiments of the disclosure, refers to a variation that does not affect the overall recited composition, property, quantity, method, value, or range thereof in a manner that negates an intended composition, property, quantity, method, value, or range. Where modified by the term “substantially” the claims appended hereto include equivalents according to this definition.

As used herein, any recited ranges of values contemplate all values within the range and are to be construed as support for claims reciting any sub-ranges having endpoints which are real number values within the recited range. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

### Discussion

In first embodiments herein, a composition comprises, consists essentially of, or consists of a partitioned flow obtained from a froth flotation of a mineral ore, combined with a cationic polymer.

In any one or more first embodiments herein, the partitioned flow is obtained by subjecting a comminuted mineral ore to froth flotation; and collecting the partitioned flow therefrom. In any one or more first embodiments herein, the partitioned flow is an overflow collected from a froth flotation. In any one or more first embodiments herein, the partitioned flow is an underflow collected from a froth flotation. A mineral ore includes a valuable metal product in a commercially valuable concentration therein. In any one or more first embodiments herein, the mineral ore is selected from a gold ore, a silver ore, an iron ore, an alumina ore (that is, a bauxite ore), a copper ore, a molybdenum ore, a sulfide ore, a lead ore, a zinc ore, or a copper/moly ore. A sulfide ore is a mineral ore including a valuable metal product that is present in the ore as a metal sulfide and/or a metal disulfide.

In any one or more first embodiments herein, the mineral ore is comminuted prior to the partitioning, wherein the comminuted mineral ore is a particulate having an average particle size of 500 μm or less, for example between 1 μm and 500 μm, such as 1 μm to 50 μm, or 50 μm to 100 μm, or 100 μm to 150 μm, or 150 μm to 200 μm, or 200 μm to 250 μm, or 250 μm to 300 μm, or 300 μm to 350 μm, or 350 μm to 400 μm, or 400 μm to 450 μm, or 450 μm to 500 μm.

In any one or more first embodiments herein, a partitioned flow is an overflow or an underflow from a froth flotation of a mineral ore. In any one or more first embodiments herein, the partitioned flow includes about 1 wt % to about 20 wt % of a particulate product of the froth flotation in a medium, that is, about 20 wt % of the particulate product or less and about 80 wt % to about 99 wt % of the medium. For example, in any one or more first embodiments herein, the partitioned flow includes 1 wt % to 20 wt %, or 5 wt % to 20 wt %, or 10 wt % to 20 wt %, or 1 wt % to 15 wt %, or 5 wt % to 15 wt %, or 5 wt % to 10 wt %, or 10 wt % to 15 wt %, or 15 wt % to 20 wt %, or 1 wt % to 3 wt %, or 3 wt % to 5 wt %, or 1 wt % to 5 wt % of the particulate product in a medium. In any one or more first embodiments herein, a partitioned flow includes a particulate product of the froth flotation having an average particle size of 500 μm or less, for example between 1 μm and 500 μm, such as 1 μm to 50 μm, or 50 μm to 100 μm, or 100 μm to 150 μm, or 150 μm to 200 μm, or 200 μm to 250 μm, or 250 μm to 300 μm, or 300 μm to 350 μm, or 350 μm to 400 μm, or 400 μm to 450 μm, or 450 μm to 500 μm.

In any one or more first embodiments herein, the particulate product comprises, consists essentially of, or consists of either a gangue or a mineral product. In any one or more first embodiments herein, the mineral product is the value mineral product that is the target of the froth flotation, and the gangue is the waste product separated from the mineral product during the froth flotation. In embodiments herein, “tailings” or “tailings flow” refers to a partitioned flow that is either an overflow or an underflow from a froth flotation of a mineral ore, and includes 1 wt % to 20 wt % of a gangue in a medium. In any one or more first embodiments herein, the tailings flow is a sulfide ore tailings flow.

In any one or more first embodiments herein, the medium is an aqueous medium comprising, consisting essentially of, or consisting of water. In any one or more first embodiments herein, the aqueous medium includes a cosolvent present in a mass or volume ratio of 1:1000 to 1:1 cosolvent: water, for example 1:1000 to 1:5, or 1:1000 to 1:10, or 1:1000 to 1:20, or 1:1000 to 1:30, or 1:1000 to 1:40, or 1:1000 to 1:50, or 1:1000 to 1:100, or 1:100 to 1:1, or 1:100 to 1:5, or 1:100 to 1:10, or 1:100 to 1:20, or 1:100 to 1:30, or 1:100 to 1:40, or 1:100 to 1:50, or 1:50 to 1:1, or 1:50 to 1:5, or 1:50 to 1:10, or 1:50 to 1:20, or 1:50 to 1:30, or 1:50 to 1:40, or 1:20 to 1:1, or 1:20 to 1:5, or 1:20 to 1:10; or a mass ratio of 1:1000 to 1:5, or 1:1000 to 1:10, or 1:1000 to 1:20, or 1:1000 to 1:30, or 1:1000 to 1:40, or 1:1000 to 1:50, or 1:1000 to 1:100, or 1:100 to 1:1, or 1:100 to 1:5, or 1:100 to 1:10, or 1:100 to 1:20, or 1:100 to 1:30, or 1:100 to 1:40, or 1:100 to 1:50, or 1:50 to 1:1, or 1:50 to 1:5, or 1:50 to 1:10, or 1:50 to 1:20, or 1:50 to 1:30, or 1:50 to 1:40, or 1:20 to 1:1, or 1:20 to 1:5, or 1:20 to 1:10. Suitable cosolvents include water-miscible C1-C8 alkanols, water-miscible ketones, water-miscible aldehydes, water-miscible esters, water-miscible glycols, or water-miscible glycol ethers, where “water-miscible” means that the cosolvent is soluble in water over the range of 1:99 to 99:1 cosolvent: water by weight or by volume.

In any one or more first embodiments herein, the medium is suitably characterized as having a pH of about 7 to about 14 or about 9 to about 12, for example 7.0 to 14.0, or 8.0 to 14.0, or 9.0 to 14.0, or 10.0 to 14.0, or 11.0 to 14.0, or 12.0 to 14.0, or 7.0 to 13.0, or 7.0 to 12.0, or 7.0 to 10.0, or 7.0 to 9.0, or 7.0 to 8.0, or 8.0 to 13.0, or 9.0 to 12.0, or 9.0 to 11.0, or 7.0 to 7.5, or 7.5 to 8.0, or 8.0 to 8.5, or 8.5 to 9.0, or 9.0 to 9.5, or 9.5 to 10.0, or 10.0 to 10.5, or 10.5 to 11.0, or 11.0 to 11.5, or 11.5 to 12.0, or 12.0 to 12.5, or 12.5 to 13.0, or 13.0 to 13.5, or 13.5 to 14.0.

In any one or more first embodiments herein, the cationic polymer is a compound having two or more repeat units covalently bonded to each other, further wherein at least one of the repeat units includes a cationic moiety covalently bonded thereto and further wherein the polymer has a net cationic charge. Stated differently, the net ionic charge of all ionic moieties covalently bonded to the cationic polymer must be +1 or greater. The cationic polymer is synthetic, or derived from natural sources, or is a synthetically modified polymer derived from natural sources. In embodiments, the cationic moiety is amine or ammonium. In some embodiments, the cationic polymer is crosslinked. In some embodiments, the cationic polymer is a combination of two or more chemically different cationic polymers; chemical differences include one or more of: molecular weight, an average molecular weight, repeat unit chemistry/structure, degree of branching, degree of crosslinking, net charge of the polymer.

In any one or more first embodiments herein, the cationic polymer comprises, consists essentially of, or consists of a homopolymer or a copolymer of a diallyldimethylammonium halide. In any one or more first embodiments herein, the cationic polymer comprises, consists essentially of, or consists of a homopolymer or a copolymer of diallyldimethylammonium chloride (DADMAC). In any one or more first embodiments herein, the cationic polymer consists essentially of, or consists of a DADMAC homopolymer. In some embodiments, the cationic polymer is characterized by a molecular weight of about 1000 g/mol to about 1×10⁷ g/mol, when the molecular weight is a weight average molecular weight, and/or wherein the molecular weight is measured by gel permeation chromatography; for example, about 2000 g/mol to 1×10⁷ g/mol, or about 3000 g/mol to 1×10⁷ g/mol, or about 5000 g/mol to 1×10⁷ g/mol, or about 7000 g/mol to 1×10⁷ g/mol, or about 10,000 g/mol to 1×10⁷ g/mol, or about 30,000 g/mol to 1×10⁷ g/mol, or about 50,000 g/mol to 1×10⁷ g/mol, or about 70,000 g/mol to 1×10⁷ g/mol, or about 100,000 g/mol to 1×10⁷ g/mol, or about 100,000 g/mol to 1×10⁶ g/mol, or about 1000 g/mol to 1×10⁶ g/mol, or about 30,000 g/mol to 1×10⁶ g/mol, or about 40,000 g/mol to 1×10⁶ g/mol, or about 5000 g/mol to 1×10⁶ g/mol, or about 10,000 g/mol to 1×10⁶ g/mol, or about 50,000 g/mol to 1×10⁶ g/mol, or about 100,000 g/mol to 1×10⁶ g/mol, or about 200,000 g/mol to 1×10⁶ g/mol, or about 300,000 g/mol to 1×10⁶ g/mol, or about 1000 g/mol to 500,000 g/mol, or about 5,000 g/mol to 500,000 g/mol, or about 10,000 g/mol to 500,000 g/mol, or about 50,000 g/mol to 500,000 g/mol, or about 100,000 g/mol to 500,000 g/mol, or 1000 g/mol to 5000 g/mol, or 5000 g/mol to 10,000 g/mol, or 10,000 g/mol to 50,000 g/mol, or 50,000 g/mol to 100,000 g/mol, or 100,000 g/mol to 150,000 g/mol; or 150,000 g/mol to 200,000 g/mol; or 250,000 g/mol to 500,000 g/mol; or 500,000 g/mol to 1×10⁶ g/mol, or 1×10⁶ g/mol to 1×10⁷ g/mol, or about 10,000 g/mol to about 300,000 g/mol, or about 10,000 g/mol to about 200,000 g/mol, or about 100,000 g/mol to about 200,000 g/mol, or about 100,000 g/mol to about 500,000 g/mol, or about 200,000 g/mol to 1×10⁶ g/mol.

In any one or more first embodiments herein, the cationic polymer includes one or more anionic monomer residues such as those bearing carboxylate, phosphonate, or sulfonate moieties covalently bonded thereto, wherein the total or net charge of the polymer is +1 or greater. Stated differently, the sum of anionic and cationic moieties bonded to the cationic polymer is +1 or greater. In one or more first embodiments herein, the cationic polymer includes one or more nonionic monomer residues such as those bearing amide, imide, ester, ether, olefinic, or other moieties covalently bonded thereto, wherein the total or net charge of the polymer is +1 or greater.

In any one or more first embodiments herein, the cationic polymer is present in a treated partitioned flow in an amount of about 0.1 ppm to about 1000 ppm by weight of the particulate product (mineral product or gangue) present in the partitioned flow, for example 0.1 ppm to 1000 ppm, or 1 ppm to 1000 ppm, or 10 ppm to 1000 ppm, or 50 ppm to 1000 ppm, or 100 ppm to 1000 ppm, or 200 ppm to 1000 ppm, or 300 ppm to 1000 ppm, or 400 ppm to 1000 ppm, or 500 ppm to 1000 ppm, or 600 ppm to 1000 ppm, or 700 ppm to 1000 ppm, or 800 ppm to 1000 ppm, or 900 ppm to 1000 ppm, or 0.01 ppm to 500 ppm, or 0.1 ppm to 500 ppm, or 1 ppm to 500 ppm, or 10 ppm to 500 ppm, or 100 ppm to 500 ppm, or 200 ppm to 500 ppm, or 300 ppm to 500 ppm, or 400 ppm to 500 ppm, or 0.01 ppm to 0.1 ppm, or 0.1 ppm to 1 ppm, or 1 ppm to 2 ppm, or 2 ppm to 3 ppm, or 3 ppm to 4 ppm, or 4 ppm to 5 ppm, or 5 ppm to 6 ppm, or 6 ppm to 7 ppm, or 7 ppm to 8 ppm, or 8 ppm to 9 ppm, or 9 ppm to 10 ppm, or 10 ppm to 12 ppm, or 12 ppm to 14 ppm, or 14 ppm to 16 ppm, or 16 ppm to 18 ppm, or 18 ppm to 20 ppm, or 1 ppm to 20 ppm, or 5 ppm to 20 ppm, or 5 ppm to 10 ppm, or 10 ppm to 15 ppm, or 15 ppm to 20 ppm, or 10 ppm to 20 ppm, or 20 ppm to 30 ppm, or 30 ppm to 40 ppm, or 40 ppm to 50 ppm, or 50 ppm to 60 ppm, or 60 ppm to 70 ppm, or 70 ppm to 80 ppm, or 80 ppm to 90 ppm, or 90 ppm to 100 ppm, or 100 ppm to 200 ppm, or 200 ppm to 300 ppm, or 300 ppm to 400 ppm, or 400 ppm to 500 ppm, or 500 ppm to 600 ppm, or 700 ppm to 800 ppm, or 800 ppm to 900 ppm, or 900 ppm to 1000 ppm, or 0.1 ppm to 100 ppm, or 1 ppm to 100 ppm, or 10 ppm to 100 ppm, or 20 ppm to 100 ppm, or 30 ppm to 100 ppm, or 40 ppm to 100 ppm, or 50 ppm to 100 ppm, or 60 ppm to 100 ppm, or 70 ppm to 100 ppm, or 80 ppm to 100 ppm, or 100 ppm to 110 ppm, or 110 ppm to 120 ppm, or 120 ppm to 130 ppm, or 130 ppm to 140 ppm, or 140 ppm to 150 ppm, or 150 ppm to 200 ppm, or 200 ppm to 250 ppm, or 250 ppm to 300 ppm, or 300 ppm to 350 ppm, or 350 ppm to 400 ppm, or 400 ppm to 450 ppm, or 450 ppm to 500 ppm, or 500 ppm to 550 ppm, or 550 ppm to 600 ppm, or 600 ppm to 650 ppm, or 650 ppm to 700 ppm, or 700 ppm to 750 ppm, or 750 ppm to 800 ppm, or 800 ppm to 850 ppm, or 850 ppm to 900 ppm, or 900 ppm to 950 ppm, or 950 ppm to 1000 ppm, by weight of the particulate product in the partitioned flow.

As noted above, a partitioned flow collected from a flotation containment, or flotation cell, or a flotation circuit, is applied to a conduit and transported therein toward a concentration containment, or thickener bed. The transporting of the partitioned flow through the conduit may be obtained by gravity, aided by a continuous supply of partitioned flow entering into the conduit as a result of the configuration of a specific mineral ore processing system. In some cases, in addition to or instead of a gravity-based flow, an applied force is applied to the partitioned flow to urge the flow through the conduit, for example by use of a pump, often a centrifugal pump. During the transporting of a partitioned flow through a conduit, some of the particulate product present in the partitioned flow can become deposited onto the interior surface of the conduit contacted by the partitioned flow during transit thereof between a froth flotation cell and a thickener bed. Such deposited solids can remain associated with the conduit interior surface, building up over time and leading to severe problems for operators in maintaining reasonable rates of overflow and/or underflow transport.

Unexpectedly, we have found that the settling rate of a particulate product from any one or more treated partitioned flows in accordance with first embodiments herein is reduced when compared to the settling rate of the particulate product from the partitioned flow—that is, the partitioned flow in the absence of the cationic polymer. “Settling rate” or “rate of settling” herein refers to the comparative amount of gravity-based solids accumulation obtained by a partitioned flow that is undisturbed within a containment for a set period of time, as is measured in accordance with the following static settling test or a variation thereof that is designed to measure solids settled from an aqueous medium. A volume of a partitioned flow is added to a flat-bottomed cylindrical column fitted with a plunger that is not impeded by the walls of the cylinder, such that the plunger can be dropped into the empty cylinder to contact the cylinder bottom solely by force of gravity. A material to be tested for efficacy in preventing settling is added to the cylinder in an amount based on the weight of solids present in the partitioned flow; and the plunger is engaged with the cylinder to mix the material thoroughly with the partitioned flow. The plunger is then removed from the cylinder, and the cylinder is allowed to stand undisturbed for 15 minutes. At the end of the 15 minutes, the plunger is dropped into the cylinder from the surface of the undisturbed contents; if the dropped plunger reaches the bottom of the cylinder, no settling has occurred in the 15 minutes. Otherwise, settled solids at the bottom of the cylinder impede the plunger from reaching the bottom; and the distance between the bottom of the cylinder interior and the bottom of the plunger after dropping it into the cylinder approximates a volume of solids settled in the cylinder. The relative rate of settling is determined by repeating the foregoing test, varying materials added and/or amount of material added to the partitioned flow for testing; and comparing the observed amount of settled solids against a control, where no material added to the partitioned flow in the cylinder.

In accordance with the foregoing static settling test, we have found that the settling rate of a particulate product from any one or more treated partitioned flows of first embodiments herein is reduced by 10% to 100% compared to the settling rate of the particulate product from the partitioned flow in the absence of the cationic polymer; that is, a settling rate of a treated partitioned flow of any one or more first embodiments herein is reduced by 10% to 20%, 20% to 30%, 30% to 40%, 40% to 50%, 50% to 60%, 60% to 70%, 70% to 80%, 80% to 90%, 90% to 95%, 95% to 97%, 97% to 99%, 99% to 99.9%, or 99.9% to 100%; about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 96%, about 97%, about 98%, about 99%, or about 100% compared to the partitioned flow alone.

The foregoing reduced settling rates are obtained, in any one or more first embodiments herein, for partitioned flows obtained from comminuted ores having a density of about 1 g/cm³ to about 10 g/cm³, for example 1 g/cm³ to 9 g/cm³, or 1 g/cm³ to 8 g/cm³, or 1 g/cm³ to 7 g/cm³, or 1 g/cm³ to 6 g/cm³, or 1 g/cm³ to 5 g/cm³, or 1 g/cm³ to 4 g/cm³, or 1 g/cm³ to 3 g/cm³, or 1 g/cm³ to 2 g/cm³, or 1 g/cm³ to 9 g/cm³, or 2 g/cm³ to 10 g/cm³, or 2 g/cm³ to 10 g/cm³, or 3 g/cm³ to 10 g/cm³, or 4 g/cm³ to 10 g/cm³, or 5 g/cm³ to 10 g/cm³, or 6 g/cm³ to 10 g/cm³, or 7 g/cm³ to 10 g/cm³, or 8 g/cm³ to 10 g/cm³, or 9 g/cm³ to 10 g/cm³, or 1 g/cm³ to 2 g/cm³, or 2 g/cm³ to 3 g/cm³, or 3 g/cm³ to 4 g/cm³, or 4 g/cm³ to 5 g/cm³, or 5 g/cm³ to 6 g/cm³, or 6 g/cm³ to 7 g/cm³, or 7 g/cm³ to 8 g/cm³, or 8 g/cm³ to 9 g/cm³, or 9 g/cm³ to 10 g/cm³. Separately, the foregoing reduced settling rates are obtained, in any one or more first embodiments herein, for partitioned flows having a density of about 1.0 g/cm³ to about 5.0 g/cm³, such as 1 g/cm³ to 5 g/cm³, or 1 g/cm³ to 4 g/cm³, or 1 g/cm³ to 3 g/cm³, or 1 g/cm³ to 2 g/cm³, 2 g/cm³ to 5 g/cm³, or 3 g/cm³ to 5 g/cm³, or 4 g/cm³ to 5 g/cm³, or 1 g/cm³ to 2 g/cm³, or 2 g/cm³ to 3 g/cm³, or 3 g/cm³ to 4 g/cm³, or 4 g/cm³ to 5 g/cm³. Separately, the foregoing reduced settling rates are obtained, in any one or more first embodiments herein, for partitioned flows wherein the particulate product of the froth flotation has an average particle size of 500 μm or less, for example between 1 μm and 500 μm, such as 1 μm to 50 μm, or 50 μm to 100 μm, or 100 μm to 150 μm, or 150 μm to 200 μm, or 200 μm to 250 μm, or 250 μm to 300 μm, or 300 μm to 350 μm, or 350 μm to 400 μm, or 400 μm to 450 μm, or 450 μm to 500 μm. The foregoing reduced settling rates are obtained, in any one or more first embodiments herein, for partitioned flows obtained from comminuted ores having a density of 4.0 g/cm³ or more, such as 4 g/cm³ to 10 g/cm³, or 5 g/cm³ to 10 g/cm³, or 6 g/cm³ to 10 g/cm³, or 7 g/cm³ to 10 g/cm³, or 8 g/cm³ to 10 g/cm³, or 9 g/cm³ to 10 g/cm³, or 4 g/cm³ to 5 g/cm³, or 5 g/cm³ to 6 g/cm³, or 6 g/cm³ to 7 g/cm³, or 7 g/cm³ to 8 g/cm³, or 8 g/cm³ to 9 g/cm³, or 9 g/cm³ to 10 g/cm³; and/or from comminuted ores that form partitioned flows having a density of 2.0 g/cm³ or less, such as 1 g/cm³ to 2 g/cm³, and/or from partitioned flows wherein the particulate product of the froth flotation including particles having an average particle size and/or having at least one dimension that is about 200 μm or greater, such as 200 μm to 250 μm, or 250 μm to 300 μm, or 300 μm to 350 μm, or 350 μm to 400 μm, or 400 μm to 450 μm, or 450 μm to 500 μm.

Further, we have found that a reduced rate of settling measured by the foregoing test, translates to a similarly reduced rate of deposition of solids by the partitioned flow onto a conduit surface during transportation of a partitioned flow therethrough. Accordingly, we have found that the deposition rate of a particulate product from any one or more treated partitioned flows of first embodiments herein during transportation thereof through a conduit is reduced by 10% to 100% compared to the deposition rate of the partitioned flow in the absence of the cationic polymer; that is, a deposition rate of a treated partitioned flow of any one or more first embodiments herein is reduced by 10% to 20%, 20% to 30%, 30% to 40%, 40% to 50%, 50% to 60%, 60% to 70%, 70% to 80%, 80% to 90%, 90% to 95%, 95% to 97%, 97% to 99%, 99% to 99.9%, 99.9% to 100%; or about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 96%, about 97%, about 98%, about 99%, or about 100% compared to the deposition rate of the partitioned flow alone. Notably, we have found that the foregoing results are achieved at very low concentrations of the cationic polymer in the treated partitioned flow: 1 ppm to 1000 ppm by weight based on the weight of the particulate product in the partitioned flow, as noted above, is sufficient to obtain at least a 10% reduction in deposition of particulate product within a conduit. Often, 3 ppm to 100 ppm, and in many first embodiments herein 5 ppm to 20 ppm by weight of the cationic polymer based on the weight of the particulate product in the partitioned flow is optimally present in a treated partitioned flow, though the amount required to obtain 10%-100% reduction in deposition varies in accordance with the chemistry of the partitioned flow and the particle size of the particulate product therein. In some first embodiments herein, we have found that 10 ppm to 50 ppm by weight of a cationic polymer in a partitioned flow obtains 100% reduction in settling; in some such embodiments the partitioned flow is a tailings flow. In some such embodiments, the tailings flow is formed by partitioning a sulfide ore using froth flotation.

Accordingly, we have observed that a treated partitioned flow of any of first embodiments herein obtains a reduction of 10% to 100% in the rate of deposition of solids during transportation thereof, when compared to the rate of deposition of solids by a partitioned flow during transportation thereof in the absence of the cationic polymer. In some such first embodiments, a treated partitioned flow comprising, consisting essentially of, or consisting of a partitioned flow combined with 1 ppm to 1000 ppm by weight of a cationic polymer based on the weight of the particulate product present in the partitioned flow obtains a 100% reduced rate of settling and/or deposition; in some such embodiments the partitioned flow is a tailings flow. In some such embodiments, the tailings flow is formed by partitioning a sulfide ore using froth flotation. Where the partitioned flow is a tailings flow of a sulfide ore flotation, a treated partitioned flow comprising, consisting essentially of, or consisting of the tailings flow of a sulfide ore flotation combined with 5 ppm to 100 ppm or even 5 ppm to 50 ppm by weight of a cationic polymer based on the weight of the particulate product obtains a 100% reduced rate of settling and/or deposition.

In accordance with the foregoing, disclosed herein are second embodiments that are methods of treating a partitioned flow to form a treated partitioned flow, and transporting the treated partitioned flow through a conduit. In some second embodiments, a transported treated partitioned flow is further dispensed from the conduit into a thickener bed (concentrating containment), and concentrated to form a treated concentrate. In some second embodiments, the methods herein are useful for treating a partitioned flow that is a tailings flow. In some second embodiments, the methods herein are useful for treating a partitioned flow that is a tailings flow of a sulfide ore.

As noted above, a partitioned flow is obtained by partitioning, that is, subjecting a mineral ore to froth flotation; and physically separating an overflow from an underflow to form two partitioned flows: an overflow and an underflow. In any one or more second embodiments the partitioned flows are a mineral product flow and a tailings flow. In any one or more second embodiments herein, the mineral ore is selected from gold ores, silver ores, copper ores, sulfide ores, molybdenum ores, lead ores, zinc ores, or copper/moly ores. In any one or more second embodiments herein, the mineral ore is comminuted, for example by grinding and/or milling, prior to partitioning by froth flotation, wherein a comminuted ore has an average particle size between 1 μm and 500 μm, such as 1 μm to 50 μm, or 50 μm to 100 μm, or 100 μm to 150 μm, or 150 μm to 200 μm, or 200 μm to 250 μm, or 250 μm to 300 μm, or 300 μm to 350 μm, or 350 μm to 400 μm, or 400 μm to 450 μm, or 450 μm to 500 μm.

In any one or more second embodiments herein a comminuted ore has a density of about 1 g/cm³ to about 10 g/cm³, for example 1 g/cm³ to 9 g/cm³, or 1 g/cm³ to 8 g/cm³, or 1 g/cm³ to 7 g/cm³, or 1 g/cm³ to 6 g/cm³, or 1 g/cm³ to 5 g/cm³, or 1 g/cm³ to 4 g/cm³, or 1 g/cm³ to 3 g/cm³, or 1 g/cm³ to 2 g/cm³, or 1 g/cm³ to 9 g/cm³, or 2 g/cm³ to 10 g/cm³, or 2 g/cm³ to 10 g/cm³, or 3 g/cm³ to 10 g/cm³, or 4 g/cm³ to 10 g/cm³, or 5 g/cm³ to 10 g/cm³, or 6 g/cm³ to 10 g/cm³, or 7 g/cm³ to 10 g/cm³, or 8 g/cm³ to 10 g/cm³, or 9 g/cm³ to 10 g/cm³, or 1 g/cm³ to 2 g/cm³, or 2 g/cm³ to 3 g/cm³, or 3 g/cm³ to 4 g/cm³, or 4 g/cm³ to 5 g/cm³, or 5 g/cm³ to 6 g/cm³, or 6 g/cm³ to 7 g/cm³, or 7 g/cm³ to 8 g/cm³, or 8 g/cm³ to 9 g/cm³, or 9 g/cm³ to 10 g/cm³.

In any one or more second embodiments herein, a method of treating a partitioned flow comprises, consists essentially of, or consists of adding any one or more cationic polymers of first embodiments herein to a partitioned flow as disclosed in first embodiments herein, to form a treated partitioned flow of any one of first embodiments herein. In some second embodiments herein, the adding of the one or more cationic polymers is accomplished by admixing one or more neat (that is, 100% solids) cationic polymers with a partitioned flow; in other second embodiments herein, adding the one or more cationic polymers is accomplished by admixing an aqueous cationic polymer solution or dispersion with a partitioned flow. In some such embodiments, a cationic polymer solution or dispersion includes 10 wt % to 70 wt % total of one or more cationic polymers in an aqueous medium comprising, consisting essentially of, or consisting of water, often 25 wt % to 50 wt %, and in some embodiments about 30 wt % to about 40 wt % total of one or more cationic polymers in an aqueous medium comprising, consisting essentially of, or consisting of water.

In any one or more second embodiments herein, a partitioned flow has a density of about 1.0 g/cm³ to about 5.0 g/cm³, such as 1 g/cm³ to 5 g/cm³, or 1 g/cm³ to 4 g/cm³, or 1 g/cm³ to 3 g/cm³, or 1 g/cm³ to 2 g/cm³, 2 g/cm³ to 5 g/cm³, or 3 g/cm³ to 5 g/cm³, or 4 g/cm³ to 5 g/cm³, or 1 g/cm³ to 2 g/cm³, or 2 g/cm³ to 3 g/cm³, or 3 g/cm³ to 4 g/cm³, or 4 g/cm³ to 5 g/cm³. In any one or more second embodiments herein, a partitioned flow includes has an average particle size between 1 μm and 500 μm, such as 1 μm to 50 μm, or 50 μm to 100 μm, or 100 μm to 150 μm, or 150 μm to 200 μm, or 200 μm to 250 μm, or 250 μm to 300 μm, or 300 μm to 350 μm, or 350 μm to 400 μm, or 400 μm to 450 μm, or 450 μm to 500 μm.

In any one or more second embodiments herein, adding a cationic polymer to a partitioned flow is accomplished within a froth flotation cell, and prior to dispensing a collected overflow or underflow therefrom. In any one or more second embodiments herein, adding a cationic polymer to a partitioned flow is accomplished by directing a partitioned flow from a froth flotation cell to a conduit, and then pumping, injecting, or pouring one or more cationic polymers or a solution/dispersion thereof into the conduit proximal to the froth flotation cell; in some such embodiments, one or more additional mixing steps may be carried out, such as stirring. In any one or more second embodiments herein, the adding of one or more cationic polymers to a partitioned flow is accomplished as the partitioned flow is in process of exiting the flotation cell, and as it is being applied to a conduit, for example at a valve point or “gate” that facilitates dispensing of a collected partitioned flow into the conduit. In some second embodiments herein, after adding the cationic polymer to the partitioned flow, the combined materials are mixed using static or active mixing, or by allowing the turbulence of the particulate-laden flow to provide mixing of the cationic polymer with the partitioned flow to form the treated partitioned flow.

Accordingly, in any one or more second embodiments herein, a treated partitioned flow is applied to a conduit; or a partitioned flow is applied to the conduit and a cationic polymer is added to the partitioned flow within the conduit to form a treated partitioned flow. Accordingly, in any one or more second embodiments herein, the treated partitioned flow is transported through the conduit. In any one or more second embodiments herein, the conduit is a pipe or tube having an interior surface that contacts the treated partitioned flow. In any one or more second embodiments herein, a conduit comprises, consists essentially of, or consists of a metal, a plastic, a rubber, a glass, a concrete, or a combination of two or more thereof. In some second embodiments herein, a conduit includes an interior surface comprising, consisting essentially of, or consisting of a concrete or a steel; or a coating or lining material such as rubber, epoxy, or silicone applied to the interior of the conduit for control of abrasion thereof.

In some second embodiments herein, the conduit is a raceway extending between, and in fluid communication with, one or more froth flotation cells, and a thickener bed; and a treated partitioned flow is applied to the raceway and transported therein in a direction from the froth flotation cell(s) toward the thickener bed. In embodiments, the treated partitioned flow, including about 1 wt % to about 20 wt % of a particulate product as noted above, is transported through the raceway at a rate of about 10 cm/s to about 20 m/s, for example 10 cm/s to 10 m/s, or 10 cm/s to 1 m/s, or 1 m/s to 20 m/s, or 1 m/s to 10 m/s, or 10 cm/s to 50 cm/s, or 50 cm/s to 100 cm/s, or 100 cm/s to 200 cm/s, or 200 cm/s to 300 cm/s, or 300 cm/s to 500 cm/s, or 500 cm/s to 1 m/s, or 1 m/s to 2 m/s, or 2 m/s to 3 m/s, or 3 m/s to 4 m/s, or 4 m/s to 5 m/s, or 6 m/s to 7 m/s, or 7 m/s to 8 m/s, or 8 m/s to 9 m/s, or 9 m/s to 10 m/s, or 10 m/s to 11 m/s, or 11 m/s to 12 m/s, or 12 m/s to 13 m/s, or 13 m/s to 14 m/s, or 14 m/s to 15 m/s, or 15 m/s to 16 m/s, or 16 m/s to 17 m/s, or 17 m/s to 18 m/s, or 18 m/s to 19 m/s, or 19 m/s to 20 m/s. In embodiments, the transporting of the treated partitioned flow through the raceway obtains a rate of about 100 metric tons to about 10,000 metric tons of the particulate product moving through the raceway per hour; hereinafter “tons” means metric tons unless otherwise indicated. For example, in embodiments, the transporting of the treated partitioned flow through the raceway obtains a rate of 100 tons to 10,000 tons, or 100 tons to 9,000 tons, or 100 tons to 8,000 tons, or 100 tons to 7,000 tons, or 100 tons to 6,000 tons, or 100 tons to 5,000 tons, or 100 tons to 4,000 tons, or 100 tons to 3,000 tons, or 100 tons to 2,000 tons, or 100 tons to 1,000 tons, or 300 tons to 10,000 tons, or 500 tons to 10,000 tons, or 1,000 tons to 10,000 tons, or 2,000 tons to 10,000 tons, or 3,000 tons to 10,000 tons, or 4,000 tons to 10,000 tons, or 5,000 tons to 10,000 tons, or 6,000 tons to 10,000 tons, or 7,000 tons to 10,000 tons, or 8,000 tons to 10,000 tons, or 9,000 tons to 10,000 tons, or 100 tons to 300 tons, or 300 tons to 500 tons, or 500 tons to 1,000 tons, or 1,000 tons to 2,000 tons, or 2,000 tons to 3,000 tons, or 3,000 tons to 4,000 tons, or 4,000 tons to 5,000 tons, or 5,000 tons to 6,000 tons, or 6,000 tons to 7,000 tons, or 7,000 tons to 8,000 tons, or 8,000 tons to 9,000 tons or 9,000 tons to 10,000 tons of particulate product moving through the raceway per hour.

As noted above, a partitioned flow from a flotation containment, or flotation cell, such as a flotation cell that is part of a flotation circuit, is applied to a raceway and transported therein toward a concentration containment, or thickener bed. In any one or more second embodiments herein, transporting of a treated partitioned flow through a raceway is obtained by gravity; in some such embodiments the transporting is further aided by a continuous mass of partitioned flow (or treated partitioned flow) entering the raceway during a continuous froth flotation process, such as from a froth flotation circuit. In some second embodiments, an additional force is applied to a treated partitioned flow within a conduit or raceway, to urge the treated partitioned flow therethrough, for example by the use of a pump. In embodiments, a raceway comprises or consists essentially of a launder, or flume, wherein a sloping trough feature facilitates transportation; in some embodiments, transportation within a launder is promoted by rollers.

Accordingly, in any one or more second embodiments herein, a method of transporting a treated partitioned flow comprises, consists essentially of, or consists of separating a mineral ore by froth flotation to form a first partitioned flow that is a mineral product flow and a second partitioned flow that is a tailings flow; combining the first partitioned flow with a cationic polymer to form a first treated partitioned flow; applying the first treated partitioned flow to a conduit; and transporting the first treated partitioned flow through the conduit. Further, in any one or more second embodiments herein, a method of transporting a treated partitioned flow comprises, consists essentially of, or consists of separating a mineral ore by froth flotation to form a first partitioned flow that is a mineral product flow and a second partitioned flow that is a tailings flow; combining the second partitioned flow with a cationic polymer to form a second treated partitioned flow; applying the second treated partitioned flow to a conduit; and transporting the second treated partitioned flow through the conduit. Additionally, in any one or more second embodiments herein, a method of transporting a partitioned flow comprises, consists essentially of, or consists of separating a mineral ore by froth flotation to form a first partitioned flow that is a mineral product flow and a second partitioned flow that is a tailings flow; combining the first partitioned flow with a cationic polymer to form a first treated partitioned flow, applying the first treated partitioned flow to a first conduit, and transporting the first treated partitioned flow through the conduit; and combining the second partitioned flow with a cationic polymer to form a second treated partitioned flow, applying the second treated partitioned flow to a second conduit, and transporting the second treated partitioned flow through the second conduit.

Unexpectedly, we have found that during the transporting of a treated partitioned flow through a conduit in accordance with any one or more second embodiments herein, the deposition rate of a particulate product from a treated partitioned flow is reduced, when compared to the deposition rate of the particulate product from the partitioned flow—that is, the partitioned flow in the absence of the cationic polymer. As noted above, we have found that a reduced rate of settling measured by the static settling test outlined above translates into a similarly reduced rate of deposition of particulate product onto a conduit surface during transportation of a partitioned flow. Accordingly, we have found that during transportation of a treated partitioned flow, the deposition rate of a particulate product therefrom is reduced by 10% to 100% compared to the deposition rate of the particulate product from the partitioned flow in the absence of the cationic polymer. Accordingly, a deposition rate of a treated partitioned flow of any one or more first embodiments herein during transportation thereof is reduced by 10% to 20%, 20% to 30%, 30% to 40%, 40% to 50%, 50% to 60%, 60% to 70%, 70% to 80%, 80% to 90%, 90% to 95%, 95% to 97%, 97% to 99%, 99% to 99.9%, or 99.9% to 100%; about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 96%, about 97%, about 98%, about 99%, or about 100% compared to the deposition rate of the partitioned flow during transportation thereof.

In accordance with the methods of any one or more second embodiments herein, 1 ppm to 1000 ppm of a cationic polymer is added to a partitioned flow that is a sulfide overflow, a sulfide underflow, a tailings underflow, a tailings overflow, a molybdenum overflow, a molybdenum underflow, a copper overflow, a copper underflow, a copper/moly overflow, a copper/moly underflow, a lead overflow, a lead underflow, a zinc overflow, or a zinc underflow to form a treated sulfide overflow, treated sulfide underflow, treated tailings underflow, treated tailings overflow, treated molybdenum overflow, treated molybdenum underflow, treated copper overflow, treated copper underflow, treated copper/moly overflow, treated copper/moly underflow, treated lead overflow, treated lead underflow, treated zinc overflow, or treated zinc underflow, where the amount of the cationic polymer added is based on the weight of particulate product (mineral product or gangue) present in the overflow or the underflow. The treated sulfide overflow, treated sulfide underflow, treated tailings underflow, treated tailings overflow, treated molybdenum overflow, treated molybdenum underflow, treated copper overflow, treated copper underflow, treated copper/moly overflow, treated copper/moly underflow, treated lead overflow, treated lead underflow, treated zinc overflow, or treated zinc underflow is transported through a conduit. In each of the foregoing examples, during transportation thereof, the deposition rate of a particulate product from the treated underflow or overflow is reduced by 10% to 100% compared to the deposition rate of the particulate product from the partitioned flow in the absence of the cationic polymer.

In any one or more second embodiments herein, the foregoing methods further include dispensing a transported treated partitioned flow from a conduit into a thickener bed (concentration containment); and concentrating the treated partitioned flow within the thickener bed to form a treated concentrate. In any one or more such second embodiments, concentrating is accomplished by sedimentation, applied gravitational force (cyclone or centrifuge), evaporation, filtration, or a combination of two or more thereof. In any one or more second embodiments herein, a treated partitioned flow dispensed into a thickener bed does not undergo increased deposition or settling of particulate product in the thickener bed; that is, the treated partitioned flows of first embodiments are stable with respect to the reduction of settling or deposition, and the partitioned flows are not rendered unstable by the presence of the cationic polymer. Accordingly, after the period of time between forming a treated partitioned flow in accordance with any one of second embodiments herein, and dispensing the treated partitioned flow into a thickener bed, the particulate products do not obtain a flocculation response, or obtain any settling or deposition in the presence of the cationic polymer. Accordingly, the thickener bed equipment, such as rakes used to move the treated partitioned flows within the thickener bed during concentration thereof, are able to operate without impedance from settled or deposited particulate products accumulating on the surfaces thereof, when a treated partitioned flow is applied thereto. In this respect, the concentrating of a treated partitioned flow in accordance with any of second embodiments herein, obtain the same benefits as the transporting of a treated partitioned flow in accordance with any of second embodiments herein: reduction or elimination of settled or deposited particulate products obtained in both the conduit and the thickener bed improve operability and reduce downtime for cleaning; and in the case of the thickener bed, a further benefit of improved operability of rakes and/or other concentrating apparatuses is gained.

In any one or more second embodiments herein, the treated partitioned concentrates formed within the thickener bed are compositionally differentiated from the treated partitioned flows by the concentration of particulate product therein. A treated partitioned concentrate, or a partitioned concentrate (in the absence of the cationic polymer) includes at least 30% solids by weight and is up to 80% solids by weight, for example 40% to 80%, or 40% to 70%, or 50% to 80%, or 50% to 70%, or 55% to 65% solids by weight, wherein the solids comprise or consist essentially of a particulate product, that is, a mineral product or a gangue. We have found that the treated concentrates do not undergo deposition or settling of particulate product in the thickener bed; that is, the concentrates are not rendered unstable by the cationic polymer, and accordingly the particulate products do not obtain a flocculation response, or any settling or deposition in the presence of the cationic polymer, even in a high solids (≥30 wt % particulate product solids) concentrate thereof.

In any one or more second embodiments herein, the stability of the treated concentrates is sufficient to obviate the addition of conventional thickener additive, conventionally applied to a partitioned flow for the purpose of increasing stability of a partitioned flow during concentration thereof to reduce the deposition or settling of particulate products within the thickener bed and allowing a flow of concentrate to be transported from the thickener bed to a different location for further treatment, storage, or disposal (depending on whether the partitioned flow is a mineral product flow or a tailings flow). For example, a treated tailings flow and a treated tailings concentrate formed using any one or more methods of second embodiments herein may suitably exclude lime, which is a common thickener additive added to tailings flows to reduce the deposition or settling of gangue solids within a raceway as well as a thickener bed—termed “sanding” as noted above. The treated tailings flows and treated tailings concentrates formed using the methods of second embodiments herein obtain reduced or eliminated sanding, thereby obviating the need to use additional additives to improve the stability of a tailings flow during transportating and/or thickening thereof. Accordingly, the treated tailings flows and treated tailings concentrates of first and second embodiments herein further suitably exclude lime or another thickener additive for reducing settling and/or deposition of tailings solids onto conduit and thickener bed surfaces.

The following Experimental section provides exemplary findings in accord with the foregoing, without being limiting in any way.

### EXPERIMENTAL SECTION

### Example 1

A copper/moly tailings flow was obtained from a copper/moly ore processing facility where severe sanding by the tailings flow had been observed in the raceway between the froth flotation circuit and the tailings flow thickener bed. The following Static Settling Test was carried out on the tailings flow. A 1000 mL flat-bottomed cylindrical column was fitted with a plunger that is not impeded by the walls of the cylinder, such that the plunger can be dropped into the empty cylinder to contact the cylinder bottom solely by force of gravity. The cylinder was filled with the tailings flow, and plunged several times with the plunger. The plunger was then removed from the cylinder, and the cylinder was allowed to stand undisturbed for 15 minutes. At the end of the 15 minutes, the plunger was dropped into the cylinder from the surface of the undisturbed contents. The settled solids at the bottom of the cylinder impeded the plunger from reaching the cylinder bottom. The distance between the bottom of the cylinder interior and the bottom of the plunger after dropping it into the cylinder, that is, the height of the accumulated settled tailings, was 16 mm. The result of the Static Settling Test for the untreated tailings flow serves as a control against which the settling of treated tailings flows is compared.

Accordingly, the Static Settling Test was repeated three more times, except in each of the three tests a 35 wt % dispersion of poly(diallyldimethylammonium chloride) (polyDADMAC, weight average molecular weight (M_{w}) of 170,000 g/mol) in water was added to the cylinder along with the tailings flow, to obtain the amount of polyDADMAC indicated in Table 1. The height of the accumulated settled tailings was compared to the 16 mm height of the layer in the control test (tailings flow with no polyDADMAC or other material added). The results, shown in Table 1, demonstrate that polyDADMAC is effective at decreasing the level of settling in a standing column, and that 50 ppm of the polyDADMAC is sufficient to eliminate static settling.

Table 1. Dose of polyDADMAC added to a copper/moly tailings flow, in ppm by weight based on the weight of tailings solids in the copper/moly tailings flow; and observed height of accumulated settled tailings measured in the Static Settling Test.

### Plunger

Dose Height % Reduction

0 PPM 16 mm N/A (control)

10 PPM 6 mm 63%

30 PPM 2 mm 88%

50 PPM 0 mm 100%

### Example 2

The raceway of a copper/moly ore processing facility from which the tailings flow used in Example 1 was obtained was observed to suffer from severe sanding, wherein restricted movement of the tailings flow due to deposited solids in the raceway caused frequent overflowing of the raceway to occur. A continuous dosing of 30 ppm of the polyDADMAC dispersion of Example 1, based on the average amount of solids measured to be in the tailings flow and the rate of transportation of the flow within the raceway, was applied slightly downstream of the point where the tailings flow was applied to the raceway from the froth flotation circuit.

About 30 seconds after starting dosing of the polyDADMAC dispersion, a large sand bar (area of significantly accumulated deposited solids) that was present on the raceway appeared to have decreased in size. About 5 minutes after starting dosing of the polyDADMAC dispersion, the size of the sand bar was significantly decreased; and additional solids deposits near the end of the raceway, close to the thickener beds, were also observed to be decreased. Within about 15 minutes of starting dosing of the polyDADMAC dispersion, the raceway appeared to be free of deposited solids.

Then the trial was performed with an on and off again format of periodic dosing to ascertain whether the foregoing observed effects were due to normal fluctuations in the process, and not to the addition of polyDADMAC. Each time dosing of polyDADMAC was suspended, accumulated deposited solids began to form. And each time dosing was resumed, the accumulated deposited solids disappeared.

What is claimed is:

1. A composition comprising a mixture of
a cationic polymer, and
a partitioned flow from a froth flotation of a mineral ore, the partitioned flow comprising 1 wt % to 20 wt % of a particulate product of the mineral ore in a medium.

2. The composition of claim 1 wherein the mineral ore is a gold ore, a silver ore, a copper ore, a molybdenum ore, a sulfide ore, a lead ore, a zinc ore, or a copper/moly ore.

3. The composition of claim 1 wherein the particulate product is a gangue.

4. The composition of claim 1 wherein the cationic polymer comprises a poly(diallyldimethylammonium halide), optionally wherein the halide is chloride.

5. The composition of claim 4 wherein the weight average molecular weight of the poly(diallyldimethylammonium halide) is 1×10⁵ g/mol to 1×10⁶ g/mol.

6. The composition of claim 1 wherein the cationic polymer is present in the mixture in an amount of 1 ppm to 1000 ppm by weight of the particulate product, or wherein the cationic polymer is present in in the mixture in an amount of 10 ppm to 100 ppm by weight of the particulate product, or wherein the cationic polymer is present in the mixture in an amount of less than 100 ppm by weight of the particulate product.

7. The composition of claim 1 wherein the medium comprises water, further wherein the medium has a pH of 7 to 14.

8. The composition of claim 1 wherein the mineral ore has a density of 4.0 g/cm³ to 10 g/cm³ or wherein the partitioned flow has a density between 1.0 g/cm³ and 2.0 g/cm³.

9. The composition of claim 1 wherein the composition is disposed within a containment or a conduit.

10. The composition of claim 9 wherein the conduit is a raceway extending between, and in fluid communication with, a froth flotation cell and a thickener bed.

11. The composition of claim 10 wherein the composition is moving within the raceway in a direction from the froth flotation cell toward the thickener bed.

12. A method of treating a partitioned flow collected from a froth flotation of a mineral ore, the method comprising adding 1 ppm to 1000 ppm by weight of a cationic polymer to the partitioned flow to form a treated partitioned flow, the partitioned flow comprising 1 wt % to 20 wt % of a particulate product in a medium, wherein the particulate product is a mineral product or a gangue.

13. The method of claim 12 wherein the mineral ore is selected from a gold ore, a silver ore, a copper ore, a molybdenum ore, a sulfide ore, a lead ore, a zinc ore, or a copper/moly ore.

14. The method of claim 12 wherein the particulate product comprises particles having at least one dimension that is about 200 μm or greater.

15. The method of claim 12 wherein the partitioned flow has a density between 1.0 g/cm³ and 2.0 g/cm^{3.}

16. The method of claim 12 wherein the partitioned flow is a tailings flow, and the particulate product is a gangue.

17. The method of claim 12 wherein the cationic polymer comprises a poly(diallyldimethylammonium halide), optionally wherein the poly(diallyldimethylammonium halide) is poly(diallyldimethylammonium chloride) having a weight average molecular weight of 1×10⁵ g/mol g/mol to 1×10⁶ g/mol.

18. The method of claim 12 wherein the adding is adding 10 ppm to 100 ppm by weight of the cationic polymer to the partitioned flow.

19. The method of claim 12 wherein the method further comprises applying the treated partitioned flow to a conduit; and transporting the treated partitioned flow through the conduit, wherein the deposition rate of the particulate product onto a surface of the conduit during the transporting is reduced by 10% to 100% compared to the deposition rate of the particulate product obtained by transporting the partitioned flow through the conduit in the absence of the cationic polymer.

20. The method of claim 19 further comprising dispensing the transported treated partitioned flow from the conduit into a thickener bed; and concentrating the treated partitioned flow within the thickener bed to form a treated partitioned concentrate, the treated partitioned concentrate comprising 30% to 80% by weight of the particulate product.
